(19) United States
(12) Patent Application Publication
(10) Pub. No.: US 2018/0024633 A1
(43) Pub. Date: Jan. 25, 2018

(54) Using Eye Tracking to Display Content According to Subject's Interest in an Interactive Display System

(71) Applicant: Aivia, Inc., Pleasant Hill, CA (US)

(72) Inventor: Chungwen Dennis Lo, Palo Alto, CA (US)

(21) Appl. No.: 15/657,067

(22) Filed: Jul. 21, 2017

Related U.S. Application Data
(60) Provisional application No. 62/365,234, filed on Jul. 21, 2016.

(51) Int. Cl. G06F 3/01; G06T 7/70; G06T 7/20; A47F 13/00; H04N 7/18; G06K 9/00; H04N 5/232; G06T 7/80; G06F 3/14

(52) U.S. Cl. CPC G06F 3/013; G06T 7/80; G06T 7/70; G06T 7/20; G06F 3/1423; H04N 7/183; G06K 9/00604; G06K 9/00255; G06K 9/00369; H04N 5/23296; A47F 13/00; G06F 3/012; G06F 3/011; G06T 2207/30201; G06T 2207/30232; G06T 7/90

(57) ABSTRACT

A system interactively displays content according to subject's interest. An interactive display system includes a display and an imaging unit or camera. The interactive display system tracks a subject's eyes or head movement to determine a subject's interest. Then, the system will analyze the subject's behavior and make decisions on what content to display on a screen based on the subject's interest.

### CROSS-REFERENCE TO RELATED APPLICATIONS

This patent application claims the benefit of U.S. patent application 62/365,234, filed Jul 21, 2016, which is incorporated by reference along with all other references cited in this application.

### BACKGROUND OF THE INVENTION

The invention relates to the field of electronic displays, and more specifically to an interactive display system that can unobtrusively track a subject's eyes or head movement and analyze subject's behavior, leading to determine the subject's interest.

Electronic displays include televisions, computer monitors, electronic billboards, mobile device screens (e.g., smartphone or tablet screens), and more are widely adopted. Electronic displays used as signage are also used in the workplace, homes and residences, commercial establishments including stores, shopping malls and dining establishments, and outdoor locations including large signs, billboards, stadiums, and public gathering areas.

A display is conventionally a display-only peripheral of a computer. A user interacts with the computer via a human input device such as a keyboard or mouse. And output from the computer is displayed on the screen. Some screens have a touch interface and the user can enter input through touch. Conventionally, a user cannot control the output of a display without physically touching a human input device or the display.

Existing electronic displays are used as signage. They are often fixed signs or play a loop or previously stored contents in a set sequence. These displays are unable to change what they display in a way that reflects the subject's behavior.

Therefore, there is a need for an improved display system to be able to interact with subject's feedback without physical touch of the display by subjects.

### BRIEF SUMMARY OF THE INVENTION

A system interactively displays content according to subject's action. The interactive display system detects and tracks a subject's eyes, head, and body movements. The system will analyze subject's behavior and make decisions on what content to display on a screen based on subject's interest. The system attempts to learn what content the subject is interested and displays content in order to maintain or gain more interest from the subject.

A display system is able to detect human presence. Once human is detected, the display content will be waving, moving, playing video, or otherwise changing content from context measurement to gain attention.

A display system is able to detect human's attention level by detecting human's behavior such as body, head, and eye movement. A display system is proactive in interacting with a human (or a user). The system detects the presence of the human (potential user) and the human's distance from the display. Then, the display can modify the size of the content accordingly (e.g., change picture size or font size), so that the content will be readable at the distance the detected human is at.

A display system is proactive in interacting with a human (or user) and find what content the human is most interested in. A display screen is divided into several sections. Independent content can be previously stored in the system or downloaded from cloud first. The system selects a content to be displayed in each section based on an action (e.g., eye or head tracking) of the human indicating interest. For the human showing no or little interest in content of a particular section, the content in that section will be replaced with content that the human would likely have greater interest in.

Alternatively, a display screen displays content sequentially and find what content human is most interested in, and display similar contents that human would likely have greater interest in.

To quantify a human's interest, a human face is detected. Then the eyes are detected and analyzed to determine a gaze direction from head pose and iris position. If the human's gaze is on content in one of section of the display for a certain period of time, this conduct is used to indicate interest. The interested content will stay on the display, and the content of the rest display sections will be replaced with other content related to or associated with the interested content. The content in each section will be continually change and updated according to interest level of the human until the human leaves (e.g., the human no longer detected by the system).

Multiple display systems can also be placed side-by-side and interact with humans. For the human showing little or no interest in content of a display system, the content in that display system will be replaced with content that the human would likely have greater interest in, as determined by the system. These multiple display systems are controlled from one or more local or remote hubs, or a combination.

To enhance the accuracy of gaze detection, several calibration methods are described for a display with multiple sections. For multiple display systems, the calibration is done similar to a display with multiple sections. Each display will display content sequentially to calibrate its own.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a simplified block diagram of a client-server system and network in which an embodiment of the invention may be implemented.

FIG. 2 shows a more detailed diagram of an exemplary client or server which may be used in an implementation of the invention.

FIG. 3 shows a system block diagram of a computer system.

FIG. 4 shows an example an interactive display system with embedded imaging sensor or camera to display content according to subject's interest.

FIG. 5A shows the scheme to display content to draw attention based on detected context awareness.

FIG. 5B shows content by group classification from context measurement.

FIG. 5C shows a flow for face detection, gaze detection, and a look-at-me condition.

FIG. 6A shows a flow for attention classification measurement by head rotation.

FIG. 6B shows a flow for attention classification measurement when viewer gets closer.

FIG. 6C shows a flow for attention classification measurement by fixation time duration.

FIG. 6D shows a flow for attention classification measurement when subject moves slower.

FIG. 7A shows a flow for gaze detection with calibration 1.

FIG. 7B shows a flow for gaze detection with calibration 2.

FIG. 7C shows a flow for gaze detection with calibration 3.

FIG. 8 shows an example of 68 points face landmarks.

FIG. 9A shows a flow for display content with gaze detection.

FIG. 9B shows a flow for gaze detection with gaze click.

FIG. 10 shows a flow for display content with face recognition.

FIGS. 11A-11F show an interactive networking content display system hardware with face and gaze detection capabilities. FIG. 11A shows a display unit with sections. FIG. 11C shows multiple display units connected to a computing unit. FIG. 11E shows an implementation with multiple imaging units or cameras. FIG. 11B, 11D, and 11F show a remote server unit.

FIG. 11G shows eye gaze detection system.

FIG. 12A shows a flow for updating content from remote server.

FIG. 12B shows a flow for uploading data from device to remote server.

FIG. 13 shows a reporting engine and an example of its reporting items.

FIG. 14 shows a remote server general consumer database.

FIG. 15 shows a system for real-time determination of a subject's interest level to media content.

FIG. 16 shows a bubble chart for display contents, context, attention, and interest aspects of the system.

FIG. 17 shows a flow of displaying contents in multiple loops.

### DETAILED DESCRIPTION OF THE INVENTION

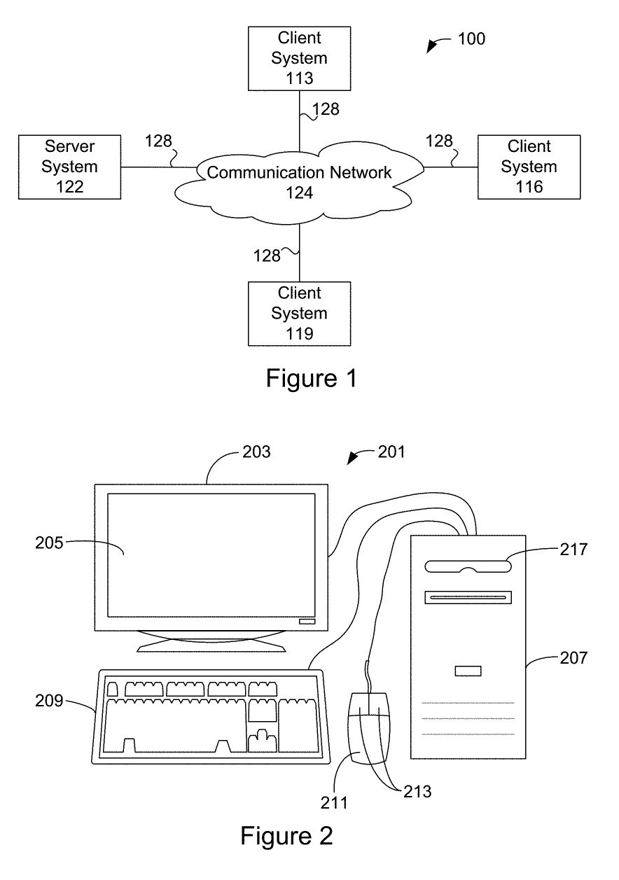

FIG. 1 is a simplified block diagram of a distributed computer network 100 incorporating an embodiment of the present invention. Computer network 100 includes a number of client systems 113, 116, and 119, and a server system 122 coupled to a communication network 124 via a plurality of communication links 128. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Communication links 128 may be DSL, Cable, Ethernet or other hardwire links, passive or active optical links, 3G, 3.5G, 4G and other mobility, satellite or other wireless communications links, wave propagation links, or any other mechanisms for communication of information.

Various communication protocols may be used to facilitate communication between the various systems shown in FIG. 1. These communication protocols may include VLAN, MPLS, TCP/IP, Tunneling, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both as a client or a server depending on whether the computer system is requesting or providing information. Additionally, although aspects of the invention have been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

Client systems 113, 116, and 119 enable users to access and query information stored by server system 122. In a specific embodiment, the client systems can run as a standalone application such as a desktop application or mobile smartphone or tablet application. In another embodiment, a “web browser” application executing on a client system enables users to select, access, retrieve, or query information stored by server system 122. Examples of web browsers include the Internet Explorer browser program provided by Microsoft Corporation, Firefox browser provided by Mozilla, Chrome browser provided by Google, Safari browser provided by Apple, and others.

In a client-server environment, some resources (e.g., files, music, video, or data) are stored at the client while others are stored or delivered from elsewhere in the network, such as a server, and accessible via the network (e.g., the Internet). Therefore, the user's data can be stored in the network or “cloud.” For example, the user can work on documents on a client device that are stored remotely on the cloud (e.g., server). Data on the client device can be synchronized with the cloud.

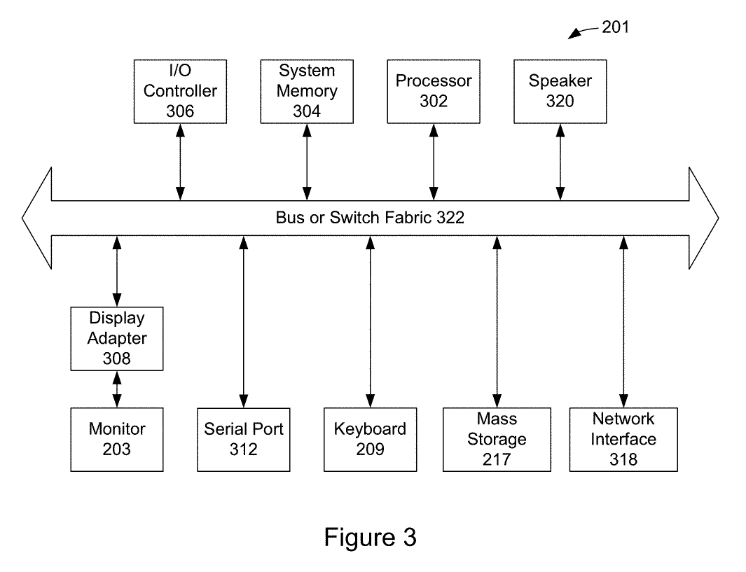

FIG. 2 shows an exemplary client or server system of the present invention. In an embodiment, a user interfaces with the system through a computer workstation system, such as shown in FIG. 2. FIG. 2 shows a computer system 201 that includes a monitor 203, screen 205, enclosure 207 (may also be referred to as a system unit, cabinet, or case), keyboard or other human input device 209, and mouse or other pointing device 211. Mouse 211 may have one or more buttons such as mouse buttons 213. The system can include one or more imaging units or cameras (not shown) such as a webcam.

It should be understood that the present invention is not limited any computing device in a specific form factor (e.g., desktop computer form factor), but can include all types of computing devices in various form factors. A user can interface with any computing device, including smartphones, personal computers, laptops, electronic tablet devices, global positioning system (GPS) receivers, portable media players, personal digital assistants (PDAs), other network access devices, and other processing devices capable of receiving or transmitting data.

For example, in a specific implementation, the client device can be a smartphone or tablet device, such as the Apple iPhone (e.g., Apple iPhone 6), Apple iPad (e.g., Apple iPad or Apple iPad mini), Apple iPod (e.g, Apple iPod Touch), Samsung Galaxy product (e.g., Galaxy S series product or Galaxy Note series product), Google Nexus devices (e.g., Google Nexus 4, Google Nexus 7, or Google Nexus 10), and Microsoft devices (e.g., Microsoft Surface tablet). Typically, a smartphone includes a telephony portion (and associated radios) and a computer portion, which are accessible via a touch screen display.

There is nonvolatile memory to store data of the telephone portion (e.g., contacts and phone numbers) and the computer portion (e.g., application programs including a browser, pictures, games, videos, and music). The smartphone typically includes a camera (e.g., front facing camera or rear camera, or both) for taking pictures and video. For example, a smartphone or tablet can be used to take live video that can be streamed to one or more other devices.

Enclosure 207 houses familiar computer components, some of which are not shown, such as a processor, memory, mass storage devices 217, and the like. Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD−R, DVD+R, DVD−RW, DVD+RW, HD-DVD, or Blu-ray Disc), flash and other nonvolatile solid-state storage (e.g., USB flash drive or solid state drive (SSD)), battery-backed-up volatile memory, tape storage, reader, and other similar media, and combinations of these.

A computer-implemented or computer-executable version or computer program product of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

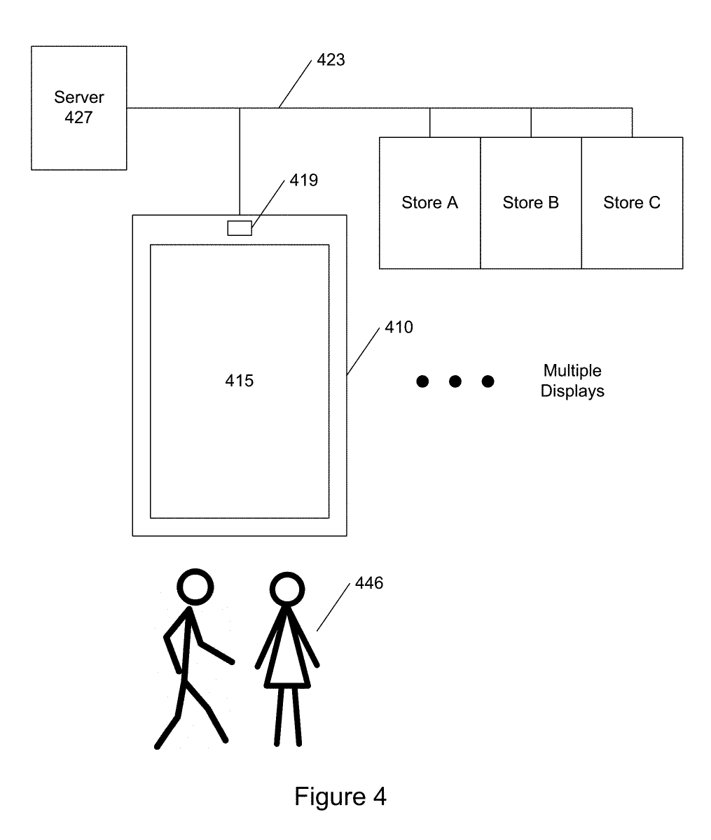

FIG. 3 shows a system block diagram of computer system 201 used to execute the software of the present invention. As in FIG. 2, computer system 201 includes monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

A bus or switch fabric 322 can represent any bus, switch, switch fabric, interconnect, or other connectivity mechanism or pathway between components of the system. For example, Arrows such as 322 can represent a system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from MathWorks, www.mathworks.com), SAS, SPSS, JavaScript, AJAX, Java, Python, Erlang, and Ruby on Rails. The computer software product may be an independent application with data input and data display modules. Alternatively, the computer software products may be classes that may be instantiated as distributed objects. The computer software products may also be component software such as Java Beans (from Oracle Corporation) or Enterprise Java Beans (EJB from Oracle Corporation).

An operating system for the system may be one of the Microsoft Windows® family of systems (e.g., Windows 95, 98, Me, Windows NT, Windows 2000, Windows XP, Windows XP x64 Edition, Windows Vista, Windows 7, Windows 8, Windows 10, Windows CE, Windows Mobile, Windows RT), Symbian OS, Tizen, Linux, HP-UX, UNIX, Sun OS, Solaris, Mac OS X, Apple iOS, Android, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, 802.11ac, and 802.11ad, just to name a few examples), near field communication (NFC), radio-frequency identification (RFID), mobile or cellular wireless (e.g., 2G, 3G, 4G, 3GPP LTE, WiMAX, LTE, LTE Advanced, Flash-OFDM, HIPERMAN, iBurst, EDGE Evolution, UMTS, UMTS-TDD, ixRDD, and EV-DO). For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

In other implementations, the user accesses the system through either or both of native and nonnative applications. Native applications are locally installed on the particular computing system and are specific to the operating system or one or more hardware devices of that computing system, or a combination of these. These applications (which are sometimes also referred to as “apps”) can be updated (e.g., periodically) via a direct internet upgrade patching mechanism or through an applications store (e.g., Apple iTunes and App store, Google Play store, Windows Phone store, and Blackberry App World store).

The system can run in platform-independent, nonnative applications. For example, client can access the system through a web application from one or more servers using a network connection with the server or servers and load the web application in a web browser. For example, a web application can be downloaded from an application server over the Internet by a web browser. Nonnative applications can also be obtained from other sources, such as a disk.

A problem is retail stores have no effective way to measure customers interest before the real sales. Some solutions include: From online search and cookie to track customer's interest, but not in retail store. Place a poster or digital media but no feedback measurement. Place a digital media and require customer input via gesture or touch screen.

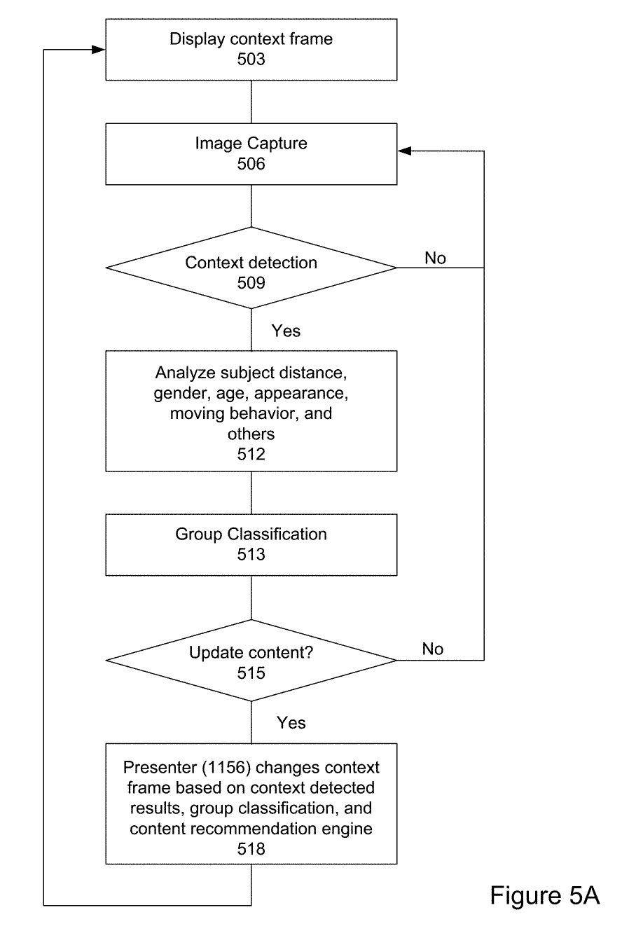

FIG. 4 shows an interactive display system 410 with eye tracking to display content according to subject's interest. Display system 410 includes a display screen 415 and a camera 419. There can be one or more displays 415 (e.g., two, three, four, five, or six or more displays) and one or more cameras 419 (e.g., two, three, four, five, or six or more cameras). The display can be any type of display screen including LCD, LED, plasma, OLED, CRT, projector, or any other device that can display information. The system can be connected via a network connection 423 to a server 427. When used in a shopping mall location or similar location, the system can be connected to a number of stores or other retail establishments, store A, store B, and store C.

Groups of people 446 can walk in front of the display and view the content displayed on the screen. The camera can detect a particular person (or user) in the group of people and can change the content based on the user's eye, head, or body movement, or any combination of these. The user's eye, head, or body movement is used by the system to determine interest or disinterest for what is displayed on the screen.

A problem is a lack of effective measurement for out-of-home (OOH) advertising. A problem is that retail stores have no effective way to measure customers' interest before the real sales. A solution is to:

1. From online search and cookie to track customer's interest, but not in retail store.

2. Place a poster or digital media but no feedback measurement.

3. Place a digital media and require customer input via gesture or touch screen.

In brief, a solution to this problem is a digital display system that includes one or multiple digital displays and an imaging system with one or more camera. The imaging system will acquire and analyze images in real-time and change the display content based on the analyzed results. This patent describes the interaction mechanism between the imaging system and contents of display.

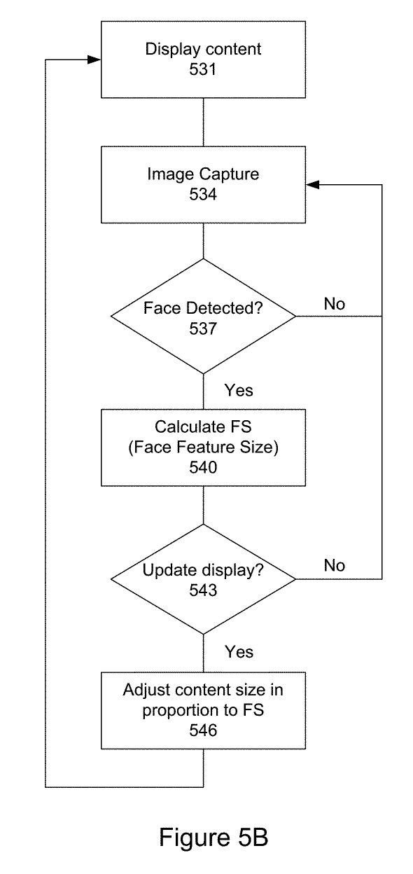

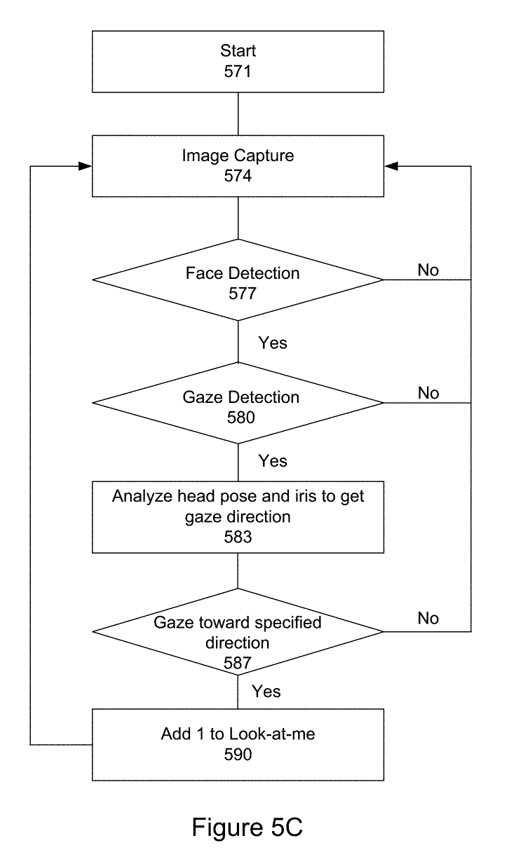

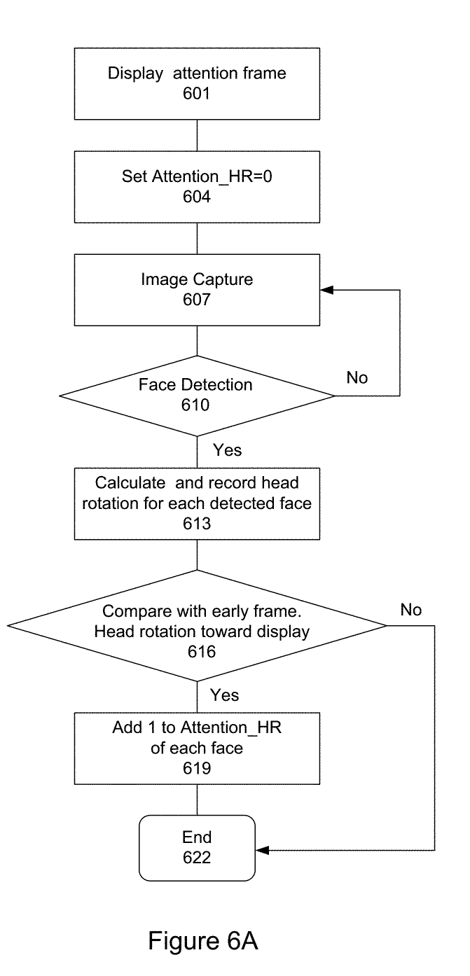

FIG. 5A shows a flow for display content based on detected context awareness to draw attention. In a step 503, a context frame is displayed on a screen. In a step 506, using a camera, an image is captured. In a step 509, a context detection is determined. If context detection determines a subject is not detected, the flow returns to step 506 to capture another image. If context detection determines a subject is detected, the flow continues to a step 512.

In step 512, the system analyzes the subject, distance, gender, age, appearance, moving behavior, color, clothes style, or other factors, or any combination of these. In a step 513, group classification is performed. Group classification includes classify users by, for example, gender, age, appearance, or posture, or any combination of these. Appearance includes, for example, clothes color, clothes shape, or pants or dress. Posture, for example, includes front facing or side view.

Some examples of moving behaviors or patterns include: whether the person is moving or standing; moving out away or moving in closer (e.g., walk out or walk in) with respect to a reference location; moving from left to right or from right to left; or near or far.

In a step 515, based on the analysis, the system determines whether to update the content on the screen. If no, the flow returns to step 506. If yes, the flow continues to a step 518. In step 518, the context frame is changed based on the results of the context detected and a content recommendation engine.

The flow determines a display content based on detected context awareness to draw attention. In various implementations, content in displayed is based on detected context awareness such as subject distance, group classification. Nearest and female have higher weighting in subject selection. Content size will be updated according to viewer distance such as face feature size. Content will be updated with content color to match viewer's dress color. Content will flash, move to get attention once detect customer in a distance. The face feature size can be used to determine or estimate a distance to the user. Once a gaze is detected, the moving content will pause or freeze (e.g., show a still image) so the user can more easily read the content.

FIG. 5B shows content size based on face feature size. In a step 531, a content is displayed. In a step 534, using a camera or other imaging device, an image is captured. In a step 537, a face detection is determined. If face detection determines a face is not detected, the flow returns to step 534 to capture another image. If face detection determines a face is detected, the flow continues to a step 540. In step 540, a face feature size (FS) is calculated. In a step 543, a display update is determined. If display is not updated, the flow returns to step 534 to capture another image. If display is updated, the flow continues to a step 546. In a step 546, content size in each section to face feature size is adjusted. The flow returns to step 531.

FIG. 5C shows a flow for face detection, gaze detection, and a look-at-me condition. In a step 571, the flow starts. In a step 574, an image is captured using the imaging device. The imaging device may be integrated with the display, as described above. However, in other implementation, the imaging device may be located in a separately from the display. For example, there may be a mannequin or other imaging device holder or stand (e.g., near the display) that incorporates the imaging device of the system. In another implementation, the imaging device may be associated just with one or more different merchandise within field of view in a retail store and track how often these merchandises are viewed and which one among the merchandises is the most viewed item.

In a step 577, a face detection is determined. If a face is not detected, the flow returns to step 574. If a face is detected, the flow continues to a step 580. In step 580, a gaze detection is determined. If a gaze is not detected, the flow returns to step 574. If a gaze is detected, the flow continues to a step 583. In step 583, the system analyzes the head pose and iris to determine a gaze direction. In a step 587, the system determines whether a gaze is toward a specific direction. If the gaze is not toward a specified direction, the flow returns to step 574. If the gaze is toward a specified direction, the flow continues to a step 590. In step 590, one is added (e.g., incremented) to a look-at-me variable. Then the flow advances to step 574. The flow determines a look-at-me detection. In various implementations, obtain a look-at-me feature. The imaging device may include standalone hardware may be mounted on an object such as the eyes of a mannequin.

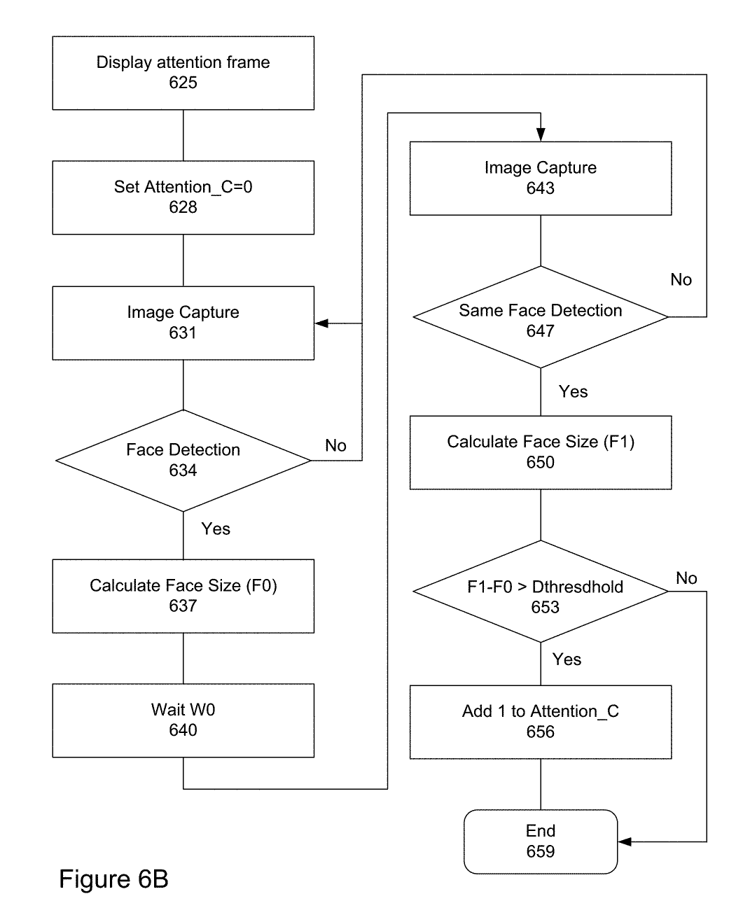

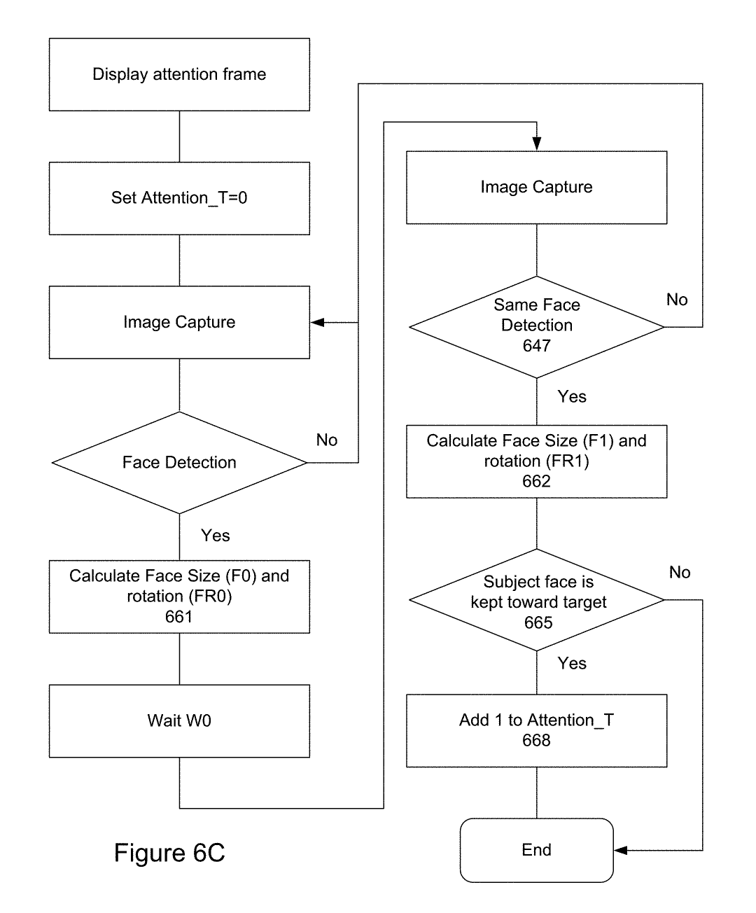

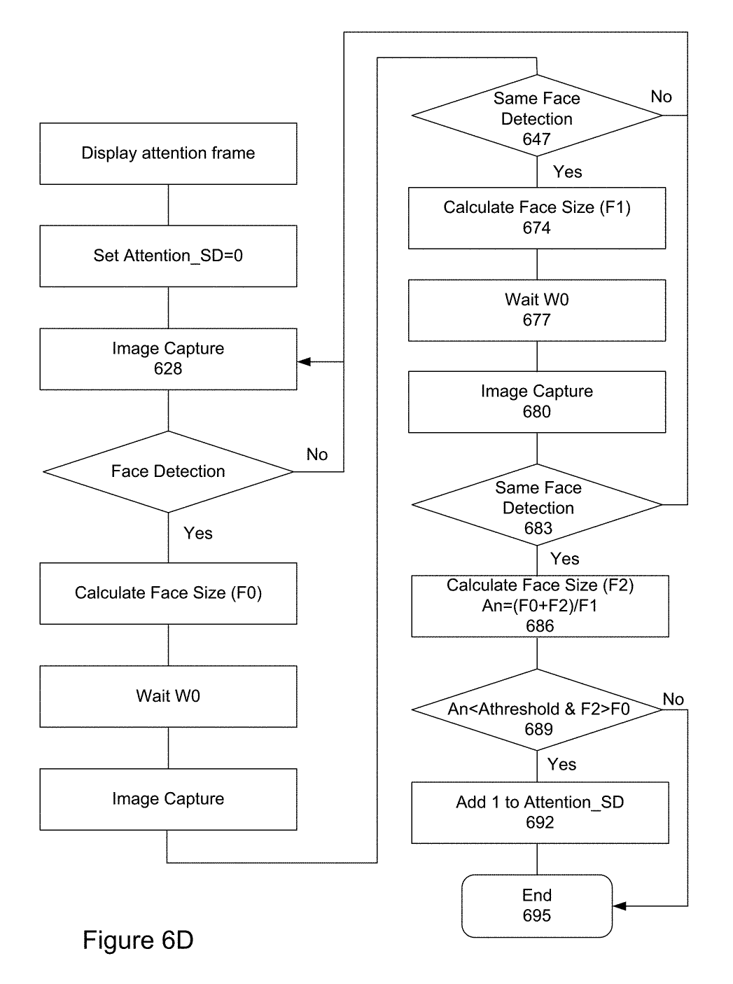

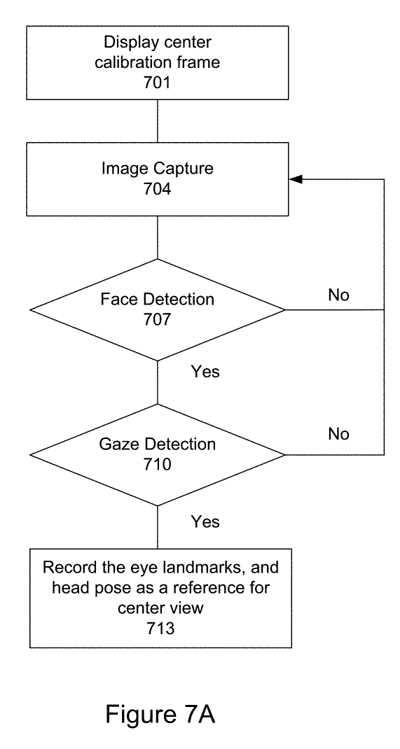

FIG. 6A shows a flow for attention classification measurement by head rotation. In a step 601, an attention frame is displayed. In a step 604, Attention_HR is set to 0. In a step 607, using a camera, an image is captured. In a step 610, a face detection is determined. If face detection determines a face is not detected, the flow returns to step 607 to capture another image. If face detection determines a face is detected, the flow continues to a step 613.

In step 613, the system calculates and records head rotation for each detected face. In a step 616, the system compares with an early frame of head rotation toward display. If no, the flow continues to an end at a step 622. If yes, the flow continues to a step 619 to add 1 to Attention_HR associated to each face. The flow then continues to an end at a step 622.

The flow determines an attention classification measurement for head rotation. In various implementations, head rotation toward target as one of attention features. Face detection includes: Head turn, toward within 90 degree. Duration, slow down, moving toward (e.g., indicating greater or enhanced attention level by user). Can apply to multiple viewers. A head rotation sensor can determine whether the user or subject is facing toward screen or not.

FIG. 6B shows a flow for attention classification measurement when a viewer gets closer. In a step 625, an attention frame is displayed. In a step 628, Attention_C is set to 0. In a step 631, using a camera, an image is captured. In a step 634, a face detection is determined. If face detection determines a face is not detected, the flow continues to a step 631 to capture another image. If face detection determines a face is detected, the flow continues to a step 637 to calculate face size (F0). In a step 640, wait time of w(0). In step 643, an image is captured.

In a step 647, if the same face in prior face detection 634 is not detected, the flow returns to capture another image at step 631. If the same face of face detection 634 is detected, the flow continues to a step 650 to calculate face size (F1). In a step 653, determine if F1-F0 is greater than Dthreshold. If no, the flow continues to an end at step 659. If yes, the flow continues to a step 656 add 1 to Attention C. The flow then continues to an end at step 659.

The flow determines an attention measurement that the view got closer. In various implementations, recognize that a detected face size increase indicates an increase in attention by the user. A distance sensor can determine if same face, then same person and face size gets bigger means customer move closer.

FIG. 6C shows a similar flow to that of FIG. 6B except for the last four steps of the flow. Instead of a step 637 in which face size (F0) is calculated, there is a step 661 in which face size (F0) and face rotation (FR0) are calculated. Instead of a step 650 in which face size (F1) is calculated, there is a step 662 in which face size (F1) and face rotation (FR1) are calculated. Instead of a step 653 in which it is determined whether F1-F0 is greater than Dthreshold, there is a step 665 in which subject face is kept toward target. Instead of a step 656 in which add 1 to attention_C, there is a step 668 in which add 1 to attention_T. In a step 671 in FIG. 6C, the flow reaches an end similar to that of step 659 in FIG. 6B.

The flow determines an attention classification measurement related to time duration. In various implementations, a detected time duration can indicate greater attention by the subject or user.

FIG. 6D shows attention classification measurement based on when the subject moves slower. FIG. 6D is similar to that of FIG. 6C except for the steps following FIG. 6B's step 647 in which same face detection (via face tracking) is determined. In FIG. 6D, after a step 647, the flow continues to a step 674 in which face size is calculated. In a step 677, wait the same of w0. In a step 680, using a camera, an image is captured. In a step 683, a same face detection is determined. If same face detection is not determined, then the flow returns to a step 628 in which another image is captured. If same face detection is determined, then the flow continues to a step 686. In step 686, calculate face size (F2) and An=(F0+F2)/F1. In a step 689, determine whether An is less than Dthreshold and F2 is greater than F0. If no, the flow continues to an end at step 695. If yes, the flow continues to a step of 692 in which add 1 to Attention_SD. In a step 695, in FIG. 6D, the flow reach an end similar to that of step 659 in FIG. 6B.

The flow determines an attention classification measurement that the subject is moving slower. In various implementations, a slow down of subject indicates greater attention by the subject. Capture single customer face sizes (F0,F1, and F2) at three times evenly spaced (by W0 milliseconds) to calculate acceleration indication A_normalized A=(F2-F1)−(F1-F0)=F2+F0−2×F1. Slower A<0. A_normalized=(F2+F0−2×F1)/F1=(F2+F0)/F1−2. Slower (F2+F0)/F1<2.

The processes in FIGS. 6A-6D can apply to track one or more faces in the captured images and apply to multiple viewers.

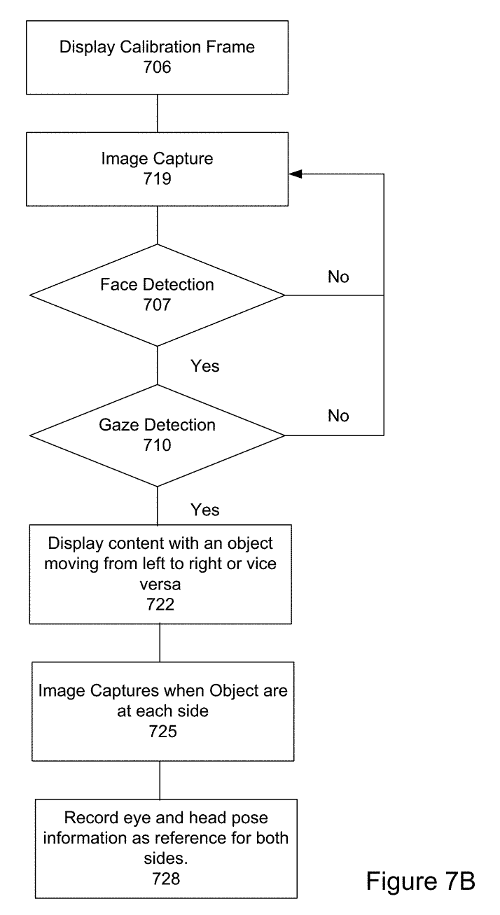

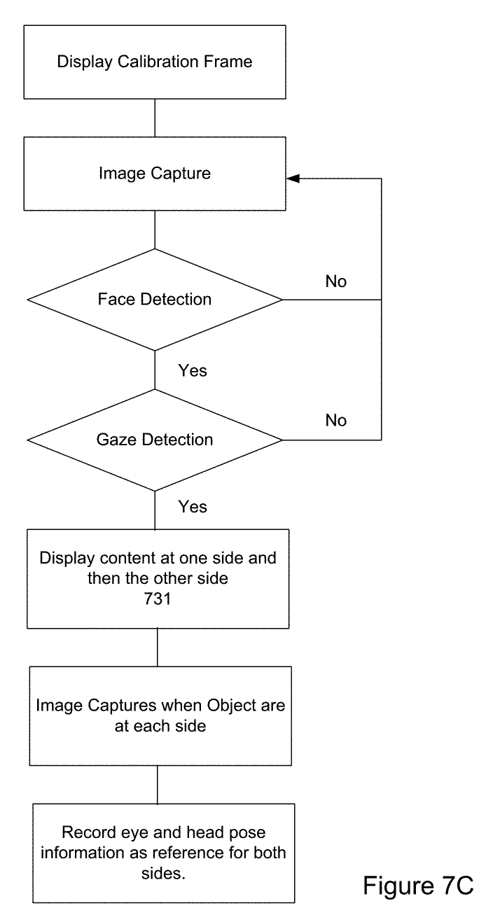

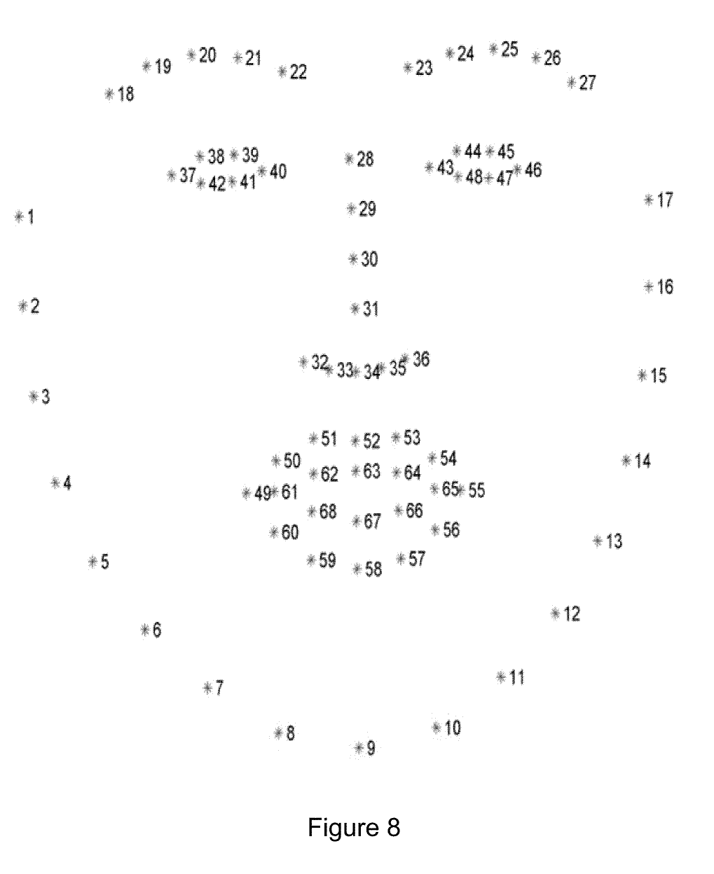

In order to determine human's gaze direction toward display system in various conditions, three calibration schemes are utilized. FIG. 7A shows a gaze calibration scheme with content displayed at the center of screen is displayed. In a step 701, a center calibration frame is displayed. In a step 704, using a camera, an image is captured. In a step 707, a face detection is determined. If a face is not detected, the flow returns to step 704. If a face is detected, the flow continues to a step 710. In a step 710, a gaze detection is determined. If gaze detection determines a gaze is not detected, the flow returns to step 704. If gaze detection determines a gaze is detected, the flow continues to step 713. In a step 713, the system records the eye landmarks, and head pose as a reference for center view. These reference parameters will be used to determine either gaze direction is relatively to left, right or remaining at the center.

In various implementations, obtain eye landmarks as a reference for content displayer at the center. The reference point will be used to determine whether viewer is looking at center, right, or left horizontally. Display contents in center, right, and left sections to simplify gaze detection. Calibration scheme applied to all imaging units within a system. Calibration will be done when it is necessary.

FIG. 7B shows gaze detection with calibration 2. In a step 706, a calibration frame is displayed. In a step 719, using a camera, an image is captured. In a step 707, a face detection is determined. If a face is not detected, the flow returns to step 719 to capture another image. If a face is detected, the flow continues to step 710 in which gaze detection is determined. If gaze detection determines a gaze is not detected, the flow returns to step 719 to capture another image. If gaze detection determines a gaze is detected, the flow continues to a step 722. In step 722, content with an object moving from left to right or vice versa is displayed. In a step 725, an image is captured when objects are on each side of the screen. In a step 728, eye and head pose information is recorded as reference for both sides.

In various implementations, obtain eye landmarks as a reference by displaying content moving from one side to the other side. These edge reference points will be used to determine where viewer is gazing at display horizontally. Content is be displayed in multiple horizontal sections to simplify gaze detection.

FIG. 7C shows gaze detection with calibration 3 and is similar to FIG. 7B except for step 722. In FIG. 7C, there is a step 731 in which content at one side and then the other side is displayed.

In various implementations, obtain eye landmarks as a reference by displaying content at the edges of display. These edge reference points will be used to determine where viewer is gazing at display horizontally. Can display contents horizontally to simplify gaze detection.

The calibration methods described above can be applied to a system with multiple displays in a similar way.

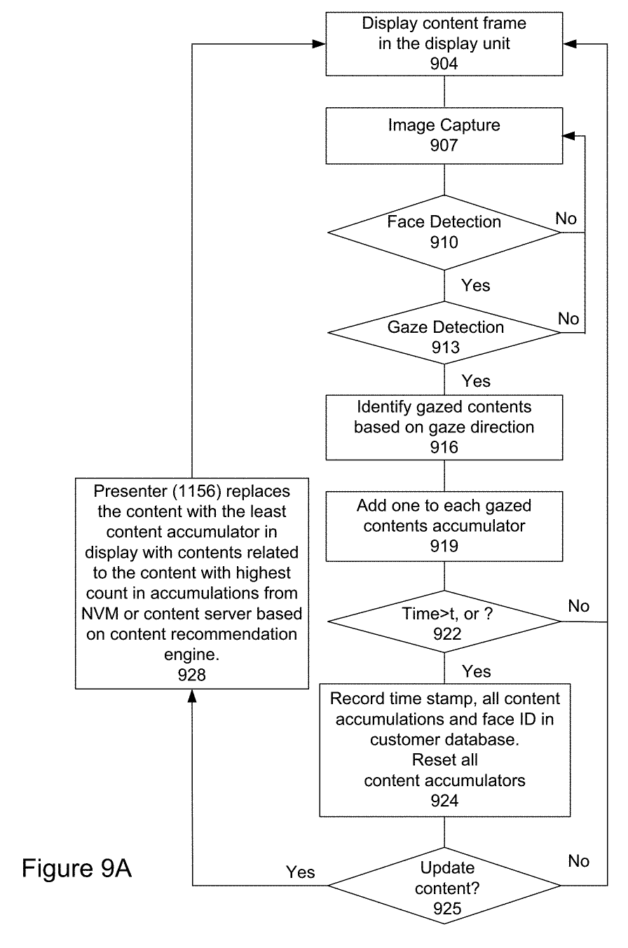

FIG. 8 shows the example of 68 points facial landmarks extracted from captured human image. Face is detected if facial landmarks can be extracted from captured image.

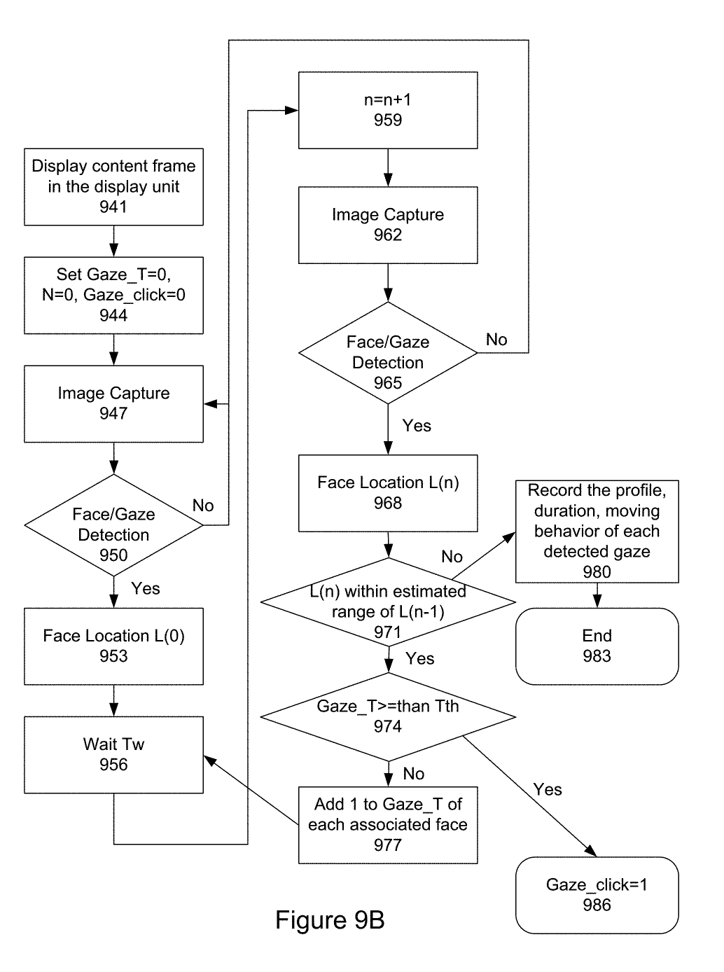

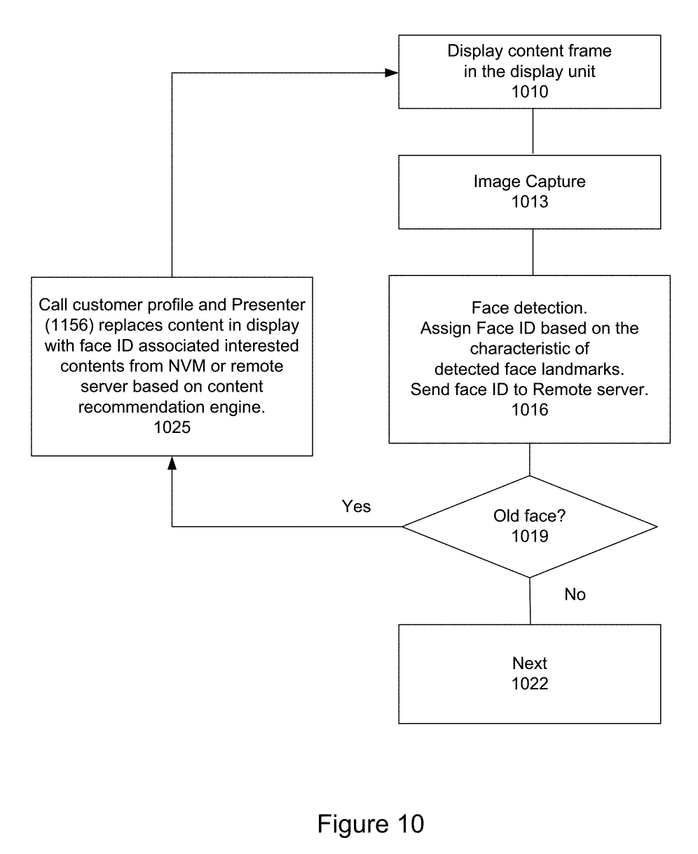

FIG. 9A shows a display content with gaze detection. In a step 904, a content frame in the display unit is displayed. In 907, using a camera, an image is captured. In a step 910, a face detection is determined. If face detection determines that a face is not detected, the flow returns to step 907 to capture image. In face detection determines that a face is determined, the flow continues to a step 913.

In a step 913, a gaze detection is determined. If gaze detection determines a gaze is not detected, the flow returns to a step 907 to capture image. If gaze detection is determined, the flow continues to a step 916. In a step 916, identity gazed contents are based on gaze direction. In a step 919, the system adds one to each gazed contents accumulator. In a step 922, determine if a time greater than a previously specified t (or other value). If no, the flow returns to step 904 to display content frame in the display unit. If yes, the flow continues to step 924 to record time stamp, all content accumulators, and face ID into customer database, and all accumulators are reset.

The flow continues to a step 925 and determines whether or not to update content. If content should not be updated, the flow returns to step 904 to display content frame in the display unit. If content should be updated, the flow continues to a step 928. In step 928, the system replaces the content with the least content accumulator in display with contents related to the content with highest count in accumulators from nonvolatile memory (NVM) or content server based on content recommendation engine.

The flow determines display content with gaze detection. The flow can apply to multiple viewers. In various implementations, can assume viewer is present via face detection. Interactively displayed gazed and gazed related contents and find viewer most interested content. Setup face ID and associated consumer database in customer profile. Content frame contains two or more items displayed horizontally with gaze direction which can be simple as left or right deviated from central calibrated position.

The flow in FIG. 9A can apply to single or multiple contents in single or multiple screens. Each screen can have only one content for single or multiple screens. The content of each screen with the least gazed content accumulator or M of out N screens can be replaced.

FIG. 9B shows a flow for gaze duration and gaze click. In a step 941, display content frame in a display unit. In a step 944, set Gaze_T=0, n=0, Gaze_click=0. In a step 947, perform an image capture. In a step 950, determine if there has been a face or gaze detection. If no, the flow returns to step 947 to capture an image. If yes, the flow continues to step 953, face location L(0). In a step 956, wait Tw. In a step 959, n=n+1.

In a step 962, perform an image capture. In a step 965, determine if there has been a face or gaze detection. If no, the flow returns to step 947 to capture an image. If yes, the flow continues to step 968, face location L(n). In a step 971, determine if L(n) within estimated range of L(n-1). If no, the flow returns to step 980 to record the profile, duration, moving behavior of each, detected gaze, and the flow ends 938.

If yes, the flow continues to step 974, to determine if Gaze_T>=than Tth. If no, the flow proceeds to step 977 to add 1 to Gaze_T of each associated face. Then the flow proceeds to step 956 to wait Tw. If yes, the flow proceeds to step 986 and Gaze_click=1.

During the eye gaze process, the system will detect human eye blinking, which is used to determine whether a real human or not (e.g., mannequin or photo).

Some gaze terminology is: Gaze Indication=gaze detected in a single frame; Gaze Detected=m/n of Gaze Indications; Gaze Duration=# times of Gaze Detected from the same face; Gaze Click=(Gaze Duration>/=Click_Threshold); and Gaze Click-through=Gaze Click+Weighting Factors.

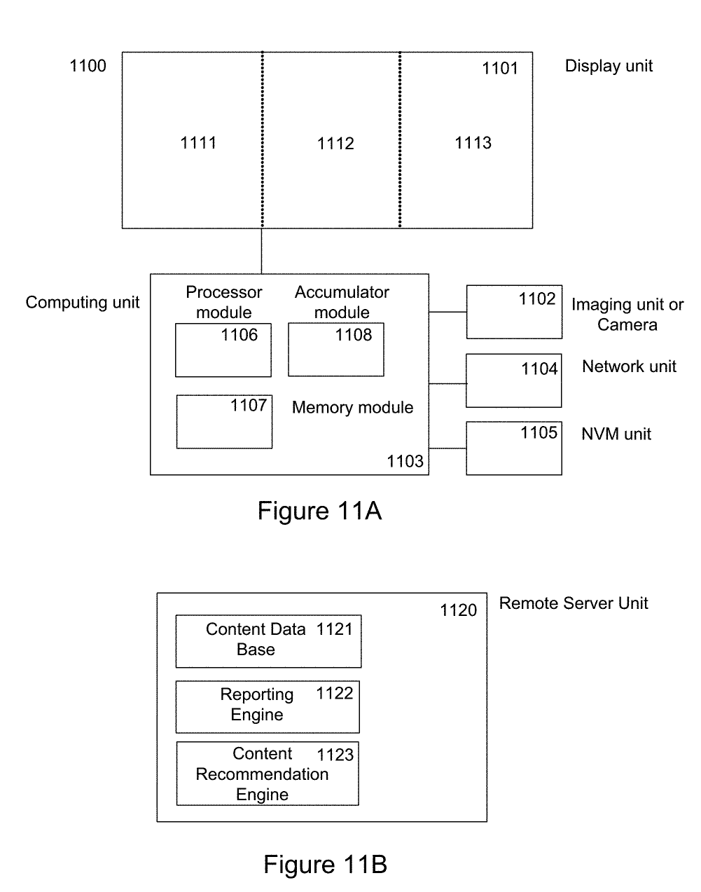

FIG. 10 shows display content with face recognition. In a step 1010, the content frame in the display unit is displayed. In a step 1013, using a camera, an image is captured. In a step 1016, face detection assigns face ID based on the characteristic of detected face landmarks. A face ID is sent to Remote server. In a step 1019, determine whether this is an old face in the existing customer profile. If no, the system continues to a step 1022 next. If yes, the system continues to call customer profile and replace content in display with face ID associated interested contents from NVM or remote server based on content recommendation engine.

The flow determines display content with face recognition. This flow can apply to multiple users. In various implementations, identify return customer based on face ID. Display initial content from return customer profile information.

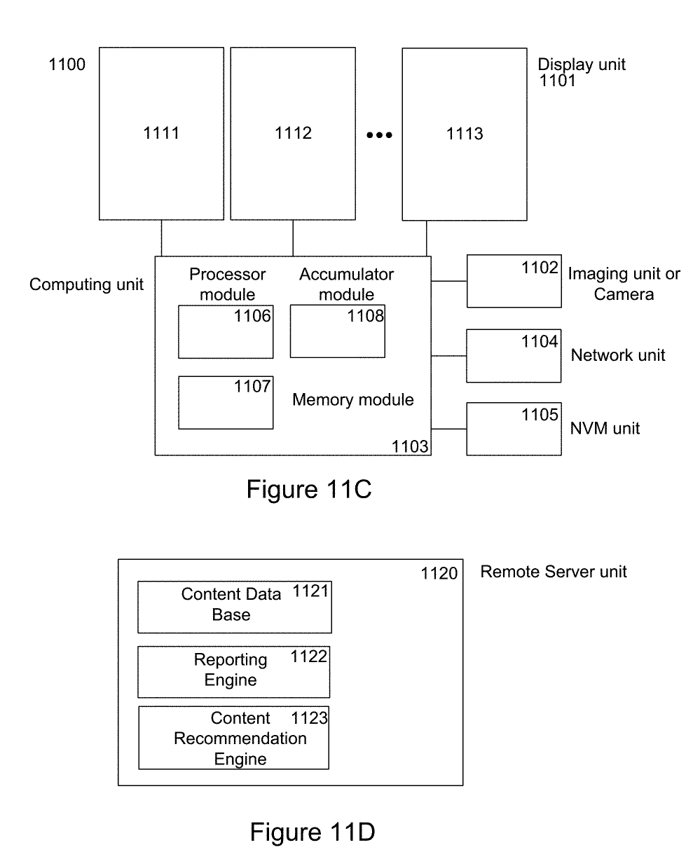

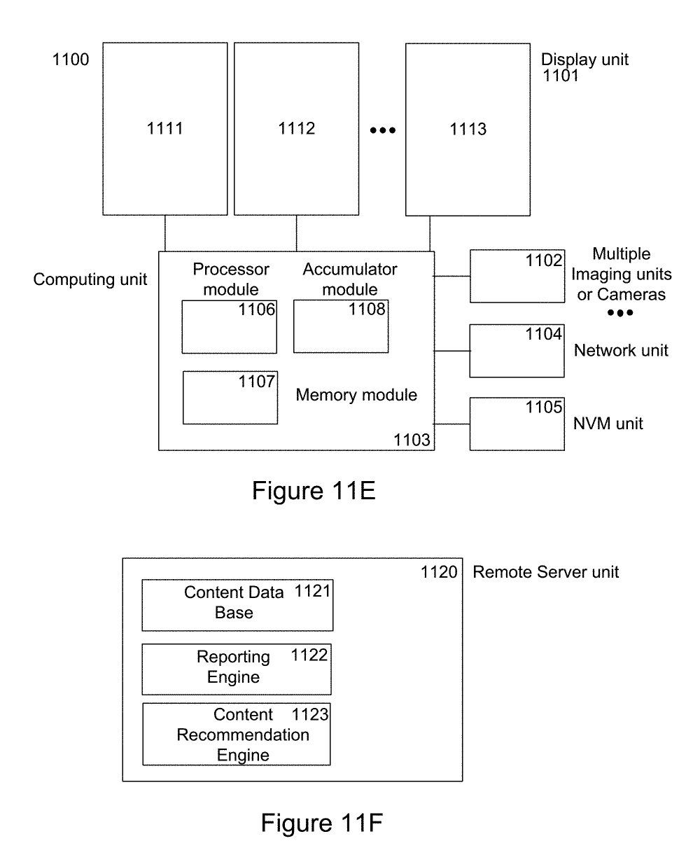

FIG. 11A shows an interactive display system 1100 with a display unit 1101 that is divided into three sections, for example, horizontally, section 1111, 1112, and 1113. FIG. 11A also shows a computing unit 1103 that is associated with a system such as system 1100. The computing unit includes a processor module 1106, memory module 1107, and accumulator module 1108. The computing unit is connected to display unit 1101, and also an imaging unit 1102, network unit 1104, and NVM unit 1105. The computing unit can be implemented by hardware, software, or firmware.

FIG. 11B shows a remote server unit 1120 that is associated with a system such as system 1100. The remote server unit includes a consumer database 1121, reporting engine 1122, and content recommendation engine 1123, which will be described below.

The system is an interactive networking content display system hardware with face and gaze detection capabilities. In various implementations, interactive networking content display system with face and gaze detection capability. Remote server with consumer database, reporting engine and recommendation engine.

Instead of multiple sections on a single panel, FIG. 11C shows multiple display units connected to a computing unit. FIG. 11E shows an implementation with multiple imaging units or cameras and multiple display units. In an implementation, there is one imaging units associated with one or more display units. For example, one imaging unit per display, or one imaging unit per two displays. Each display may be divided in two or more section, such as in FIG. 11A. In an implementation, there are two or more imaging units associated with one display unit, or two or more imaging units associated with two or more display units. In the system with multiple imaging units, the content with the least look-at-me count will be replaced. FIGS. 11D and 11F are similar to FIG. 11B.

FIG. 11G shows eye gaze detection system. A display 1165 includes or is connected to an imaging unit or camera 1162. This is connected to a 1171 to a system unit or controller. This unit can be integrated in the display or may be a separate box that is connected to the display and imaging unit. For example, the display may be connected by a video connection such as HDMI to a presenter block 1156. The imaging unit can be connected by a data connection such as USB to a real-time processor block 1159. The real-time processor can perform as a click detector, group classification, and location estimator. The location estimator includes face recognition and face tracking.

The location estimator estimates the viewer next distance and angular velocity within a movement equation and updates the movement equation parameters with estimation error. When there is no new update for a view identifier, the estimator decides whether to continue the estimation process, pass the viewer parameters to another imaging system (e.g., hop), or terminate (e.g., out of reach). When a new viewer is detected, the estimator will check if this is an existing viewer on file (e.g., known to the system) or if new, create a new view identifier.

The processor is connected to a reporter block 1153. The processor transmits or sends gaze or click data, or a combination, to the reporter. The reporter is connected to the presenter. The reporter sends click or command data, or a combination to the presenter. The reporter receives image identification information from the presenter.

This server stores customer images in a recommendation engine 1168. The images are sent via a secure path from a server to controller and stores in a buffer or storage location. The presenter receives images from a buffer or storage location of controller. The reporter generates reports and stores in a buffer or storage location. The reports are sent via a secure path to reporting engine 1150 in a server, which stores customer reports.

In various implementations, the imaging unit can be a separate unit or integrated with display unit. With only one camera is used, there is a tradeoff between field of view and distance. This can be handled by changing or selecting a different focal length for the camera. Using, selecting, or adjusting a camera to have relatively long focal length allows for far distance and scan to get wider field of view. A camera can use a rotating mirror in front to gain fast scanning and wider field of view. Multiple cameras with long focal length and facing different directions can be used to get a wider field of view. The multiple imaging units or cameras can be embedded inside display units such as LED display.

In an implementation of a system, multiple display units and multiple imaging units are connected together. When subject moves from a display unit A's coverage to a display unit B's coverage, a subject's eye is tracked such that display unit B will display content that related to what was displayed in unit A when the subject's gaze was detected in unit A.

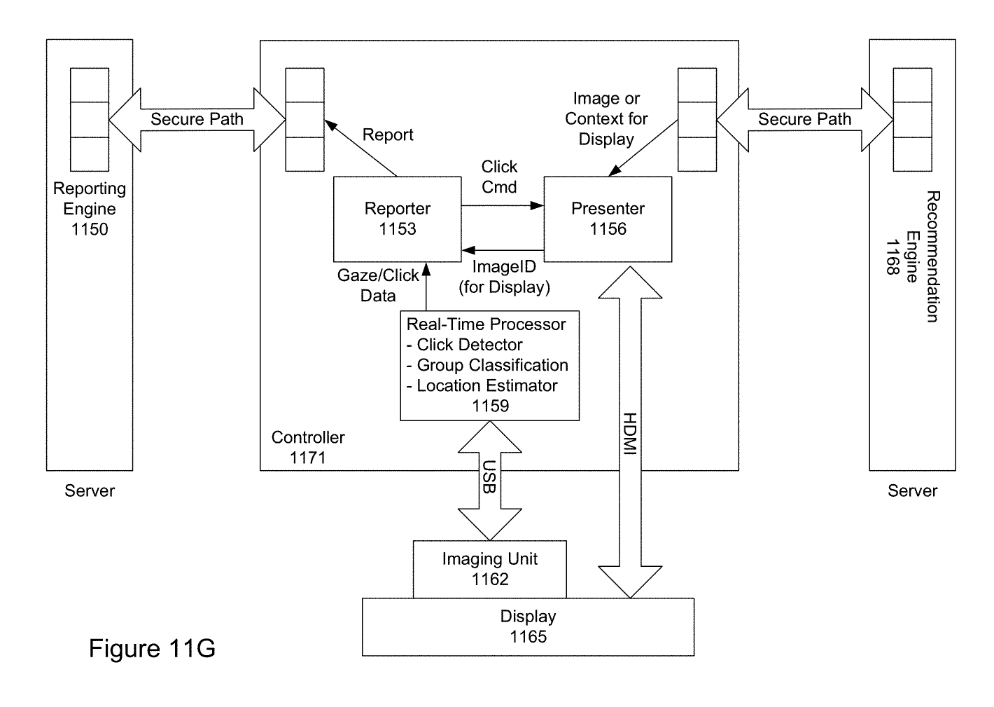

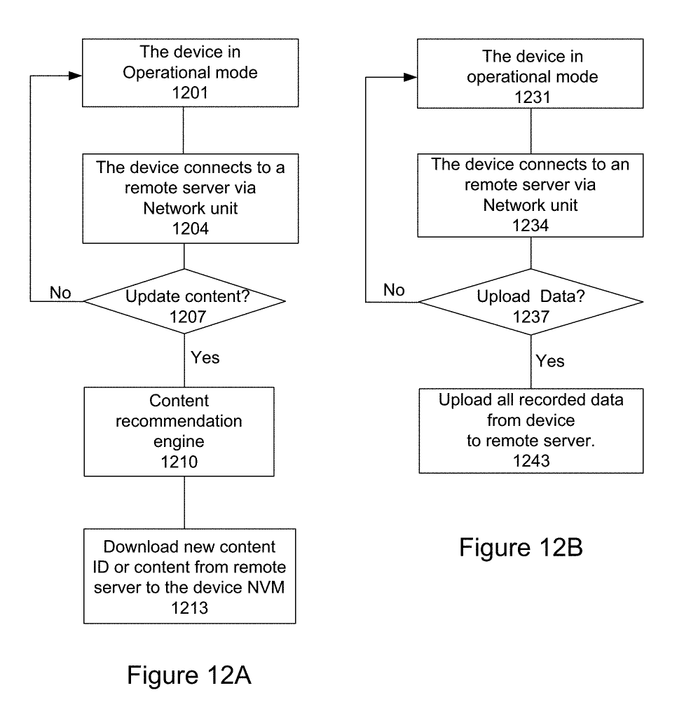

FIG. 12A shows a flow for updating content from remote server. In a step 1201, the device is in operational mode. In a step 1204, the device connects to a remote server via network unit. In a step 1207, the system decides whether or not to update content. If no, the flow returns to step 1201. If yes, the flow continues to step 1210. In a step 1210, content recommendation engine. In a step 1213, the device downloads new content ID or content from remote server to the device NVM. In a step 1216, all recorded data from device to remote server is updated.

FIG. 12B shows a flow for uploading data from device to remote server. In a step 1231, the device is in operational mode. In a step 1234, the device connects to a remote server via network unit. In a step 1237, the system decides whether or not to upload data. If no, the flow returns to step 1231. If yes, the flow continues to step 1243. In a step 1243, the device uploads all recorded data from the device to the remote server.

To maintain confidentiality of the data and improve security so personal information is not stolen, the data (such as upload and download data in step 1243) can be encrypted before sending over a network or communication link. Specifically, the unencrypted data is encrypted using an encryption algorithm. Then at the receiving end, the data is decrypted to recover the unencrypted data, which can then be processed as described in this application.

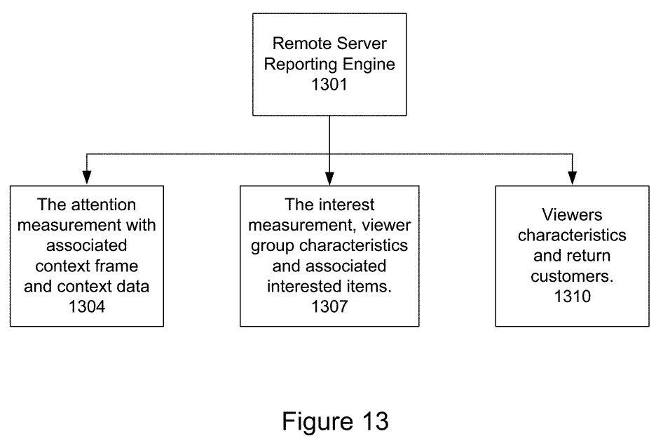

FIG. 13 shows a reporting engine. In step 1301, remote server reporting engine. In step 1304, the attention measurement with associated context frame and context data. In a step a 1307, the interest measurement, viewer group characteristics and associated interested items. In a step 1310, viewers characteristics and return customers.

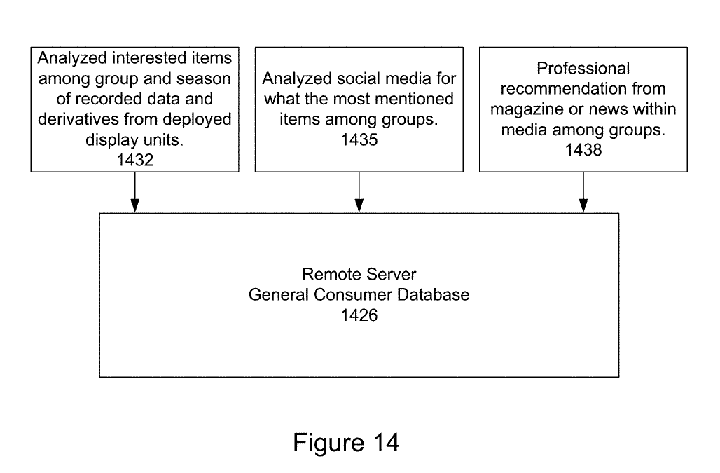

FIG. 14 shows a remote server general consumer database 1426. Information stored in the consumer database includes: (1) Information type 1432: analyzed interested items among group and season of recorded data and derivatives from deployed display units. (2) Information type 1435: analyzed social media for what the most mentioned items among groups. (3) Information type 1438: professional recommendation from magazine or news within media among groups.

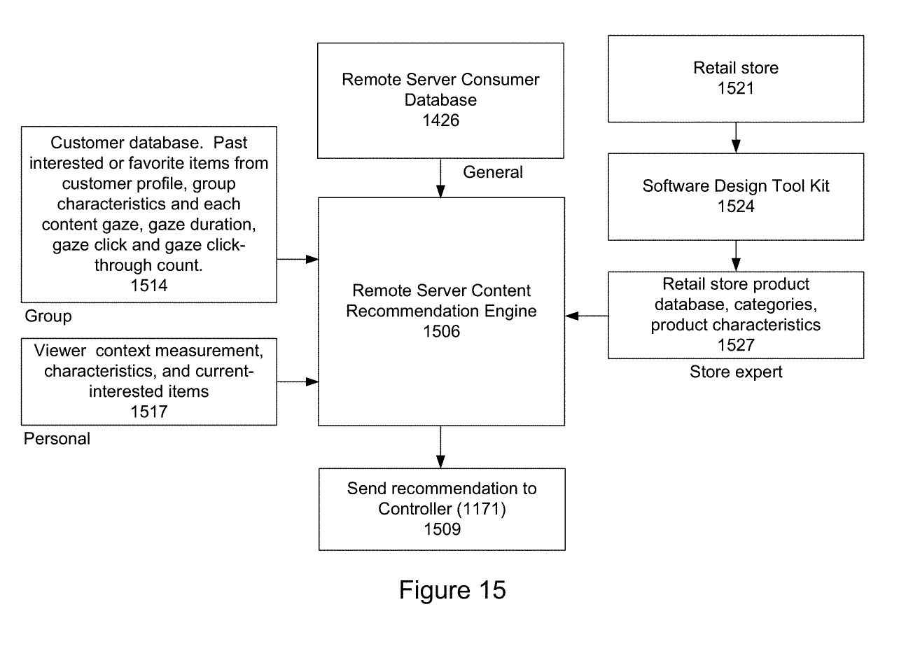

FIG. 15 shows a system for real-time determination of a subject's interest level to media content. Remote server general consumer database 1426 is an input to a remote server content recommendation engine 1506. Other inputs to the remote server content recommendation engine include group, personal, and store expertise inputs. The remote server content recommendation engine can generate and send recommendations 1509 to the display unit.

An example of a group input is a customer database 1514, which can store information on past interested and favorite items from customer profiles. Further the customer database can store group characteristics and each content gaze, gaze duration, gaze click and gaze click-through count. Examples of personal input include a viewer context measurement, characteristics, and current-interested items 1517. Regarding store expertise, information can be from a retail store 1521, which is gathered by a software design tool kit or software developers kit (SDK) 1524. The retail store product database, categories, product characteristics 1527 are input to the remote server content recommendation engine.

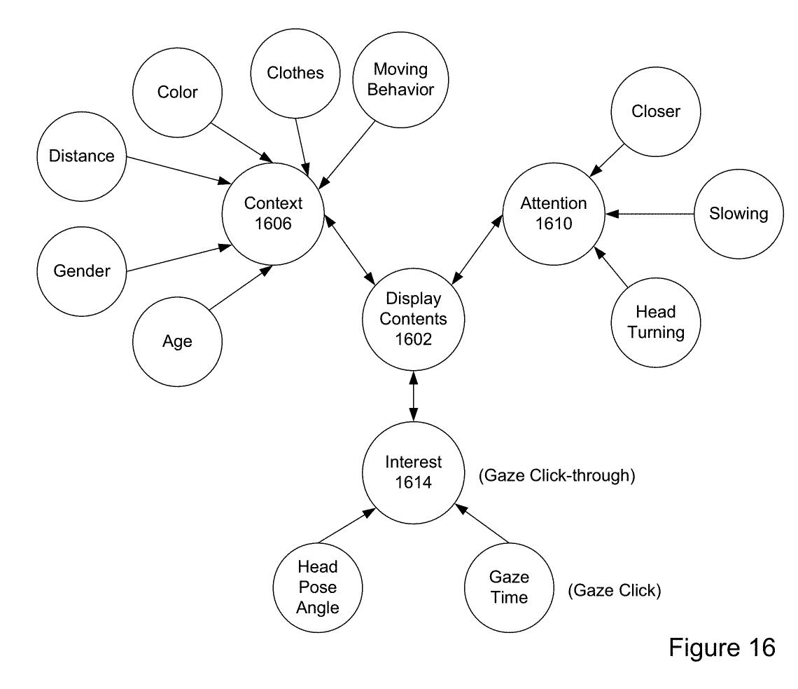

FIG. 16 shows display contents 1602 interaction with detected context 1606, attention 1610, and interest 1614. Initial context detection from subject such as clothes, color, distance, gender, and age will cause display contents to change accordingly. Any subject's action from display contents such as head turning, slowing and closer will be detected and tracked. The display contents will be interacting with subjects based on subject's interest level measured by gaze time and head pose angle.

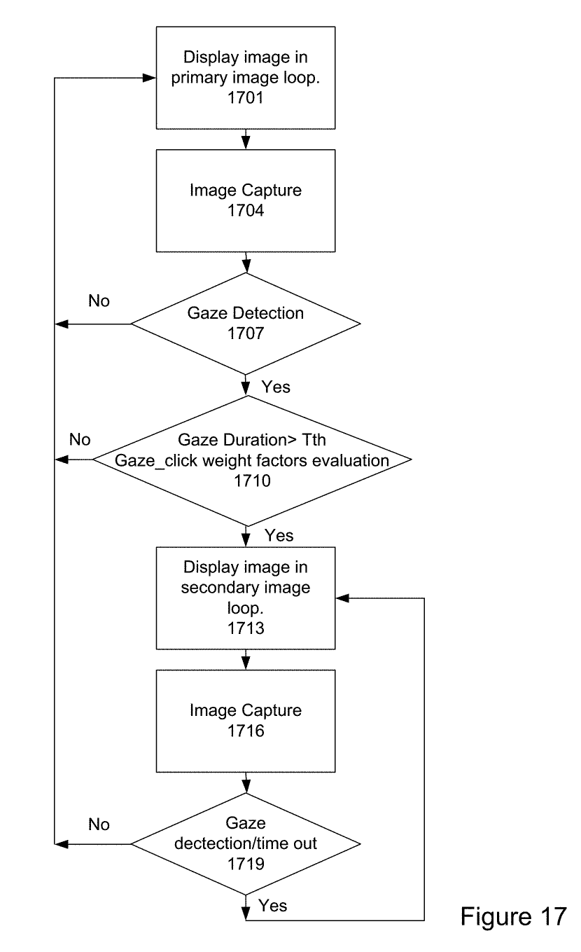

FIG. 17 shows a flow for gaze click-through. In a step 1701, display image in primary image loop. In a step 1704, perform image capture. In a step 1707, determine if a gaze detection has occurred. If no, return to step 1701. If yes, proceed to step 1710, determine if Gaze duration>Tth; Gaze_click weighting factors evaluation. If no, return to step 1701. If yes, proceed to step 1713 to display image in secondary image loop. In a step 1716, perform image capture. In a step 1719, determine if a gaze detection or time out has occurred. If no, return to step 1701. If yes, return to step 1713.

A media display in media player in digital signage typically displays media or image in a predetermined one loop sequence. Using gaze click-through, gaze click-through is used to trigger multi-loop image for targeted display. In an implementation, gaze click-through is used to select targeted display content, targeted to the person or people that caused the gaze click-through event to occur.

In an implementation, primary images will be A1, B1, C1, D1, and so forth. Secondary images will be a1, a2, a3, and so forth or b1, b2, b3, and so forth or c1, c2, c3, or so forth, and others image loops. Some Gaze_click weighting factors include, for example, click from viewers in specific area; click from close viewers (eye distance<threshold); click from specific gender; click from age group; viewer #n can click only once; and viewer #n is preferred for click (if close to click wait for viewer #n to click); click from moving behavior (fast moving versus slow or not moving).

In an implementation, a system includes: at least a first display; and at least a first imaging device; a controller block coupled to the first display and imaging device. The controller block is configured to: acquire images from the imaging device; analyze the images from the imaging device to obtain a first analysis; and alter the content shown on the first display based on the first analysis of the images, where the content shown on the first display does not include images acquired from the imaging device.

In various implementations, the system can include: a network, connected to the controller block, where the controller transmits the first analysis to a server; and the controller block is configured to cause a second display, coupled to the network and separate from the first display, to show a content based on the first analysis.

The analyze the images from the imaging device to obtain a first analysis includes the controller block being configured to: detect a gaze event of a person, where the gaze event indicates a selection by the person's eye gaze of either at least a first content or a second content shown on the first display; upon determining the gaze event is for the first content, display a third content associated with the first content on the first display; and upon determining the gaze event is for the second content, display a fourth content associated with the second content on the first display.

The controller can be configured to calibrate based on a point of interest at about a frame center, between a frame left edge and a frame right edge of the first display and between a frame top edge and a frame bottom edge of the first display. The controller can be configured to calibrate based on a point of interest moving from a frame left edge to a frame right edge of the first display or the point of interest moving from the frame right edge to the frame left edge of the first display. The controller can be configured to calibrate based on a point of interest at one side of a frame of the first display and then at an opposite side of the frame of the first display.

The controller includes a real-time processor, and the processor is configured to perform image analysis of gaze click detection, group classification, movement detection, and location estimation. The controller can include embedded storage or is coupled to external storage. The storage is used to store content images received from a server for a presenter and a reporter. Based on image analysis data, the controller determines associated display content.

The image analysis includes the controller being configured to determine a gaze duration, estimate face location, and generate a gaze_click flag when a duration is greater than a predetermined threshold time value. The image analysis includes the controller being configured to detect a movement of a person's eyes, a movement of a person's head, and movement of a person's body, a person's gender, a person's age, a person's movement behavior or patterns, a person's distance from first display, a person's hair color, a person's clothing color, a person's clothing style such as pants, skirt, or other, appearance, posture, face recognition or face tracking, or any combination of these.

The alter the content shown on the first display can be enabled by generating of a gaze_click_through flag which involves a gaze_click and weighting factors including at least one of a specific gender, age group, specific area, distance, preferred viewers, or other factors, or any combination of these. The altered content can be migrated and changed from a primary content group to secondary content group to match to a classified viewer's group.

The altered content can be a content size updated according to viewer's distance, content color to match viewer's dress color, content waving to get attention, content still from waving, or different content, or any combination of these. The imaging device can be located in a separate location than the first display. The imaging device can be positioned (e.g., embedded) in at least one of a mannequin, a merchandise, a holder, or a stand, separate from the first display.

The imaging device can incorporate a motor to rotate the imaging device itself or to rotate a front mirror to increase its field of view. Multiple display units and imaging units can be linked together, such that when a subject moves from a display unit A's coverage to a display unit B's coverage, a subject's eye is tracked such that display unit B will display content that related to what was displayed in unit A when the subject's gaze was detected in unit A. For each instance content is displayed on the first display, captured images associated with the content on the first display are analyzed to determine an interest level, where lower interest content will be replaced with content similar to high interest content either in a single display or using multiple display units. The image analysis can include a gaze blinking (e.g., detecting eye blinking) which is used to determine if a real human.

In an implementation, a kit includes: at least a first imaging device; and a controller device, where the controller device includes a display adapter configured to be connected to a first display and a port (e.g., USB or serial port) configured to be coupled to the imaging device (e.g., camera). The controller includes code (e.g., firmware, software, or software application program) executable on a processor of the controller device. The device can include: code to acquire images from the imaging device; code to analyze the images from the imaging device to obtain a first analysis; and code alter the content shown on the first display based on the first analysis of the images, where the content shown on the first display does not include images acquired from the imaging device.

In an implementation, a method includes: receiving first, second, and third content for display on a first display; storing the first, second, and third content in a memory; displaying the first content on the first display; receiving a stream of images from a first imaging device; analyzing the stream of images from the imaging device to obtain a first analysis; and based on the first analysis of the images, altering the content shown on the first display to show either the second content or the third content, where the content shown on the first display does not comprise images received using the first imaging device.

In an implementation, a method includes: receiving first, second, third, fourth, fifth, and sixth content for display on a first display; storing the first, second, third, fourth, fifth, and sixth content in a memory; displaying the first content on the first display; displaying the second content on the second display; receiving a stream of images from a first imaging device; analyzing the stream of images from the imaging device to obtain a first analysis; based on the first analysis of the images, altering the content shown on the first display to show either the third content or the fourth content, where the content shown on the first and second displays does not comprise images acquired received using the first imaging device; and based on the first analysis of the images, altering the content shown on the second display to show either the fifth content or the sixth content, where the second display is separate from the first display.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
receiving first, second, and third content for display on a first display;
storing the first, second, and third content in a memory;
displaying the first content on the first display;
receiving a stream of images from a first imaging device;
analyzing the stream of images from the imaging device to obtain a first analysis; and
based on the first analysis of the images, altering the content shown on the first display to show either the second content or the third content, wherein the content shown on the first display does not comprise images received using the first imaging device.

2. The method of claim 1 wherein the first, second, and third content are received over a network connection.

3. A method comprising:
receiving first, second, third, fourth, fifth, and sixth content for display on a first display;
storing the first, second, third, fourth, fifth, and sixth content in a memory;
displaying the first content on the first display;
displaying the second content on the second display;
receiving a stream of images from a first imaging device;
analyzing the stream of images from the imaging device to obtain a first analysis;
based on the first analysis of the images, altering the content shown on the first display to show either the third content or the fourth content, wherein the content shown on the first and second displays does not comprise images acquired received using the first imaging device; and
based on the first analysis of the images, altering the content shown on the second display to show either the fifth content or the sixth content, wherein the second display is separate from the first display.

4. The method of claim 1 wherein the analyzing the stream of images from the imaging device to obtain a first analysis comprises:
in the stream of images, detecting a gaze event of a person, wherein the gaze event indicates a selection by the person's eye gaze of either at least a first portion of the first content or a second portion of the first content shown on the display;
upon determining the gaze event is for the first portion, display the second content associated with the first portion on the first display; and
upon determining the gaze event is for the second portion, display a third content associated with the second portion on the first display.

5. The method of claim 1 comprising:
calibrating the first imaging device and the first display by using a point of interest on the first display at about a frame center, between a frame left edge and a frame right edge of the first display and between a frame top edge and a frame bottom edge of the first display.

6. The method of claim 1 comprising:
calibrating the first imaging device and the first display by using a point of interest on the first display moving from a frame left edge to a frame right edge of the first display or the point of interest moving from the frame right edge to the frame left edge of the first display.

7. The method of claim 1 comprising:
calibrating the first imaging device and the first display by using a point of interest at one side of a frame of the first display and then at an opposite side of the frame of the first display.

8. The method of claim 1 comprising:
using a real-time processor, performing an image analysis of gaze click detection, group classification, movement detection, and location estimation.

9. The method of claim 1 wherein the memory comprises embedded storage or external storage, and the storage is used to store content images received from a server for a presenter and a reporter, and method comprises based on image analysis data, determining associated display content.

10. The method of claim 1 wherein the image analysis comprises determining a gaze duration, estimate face location, and generate a gaze_click flag when a duration is greater than a predetermined threshold time value.

11. The method of claim 1 wherein the image analysis comprises detecting a movement of a person's eyes, a movement of a person's head, and movement of a person's body, a person's gender, a person's age, a person's movement behavior or patterns, a person's distance from first display, a person's hair color, a person's clothing color, a person's clothing style such as pants, skirt, or other, appearance, posture, face recognition or face tracking, or any combination of these.

12. The method of claim 1 wherein the altering the content shown on the display is enabled by generating of a gaze_click_through flag which comprises a gaze_click and weighting factors comprising at least one of a specific gender, age group, specific area, distance, preferred viewers, or other factors, or any combination of these.

13. The method of claim 1 comprising migrating altered content from a primary content group to secondary content group to match to a classified viewer's group.

14. The method of claim 1 comprising updating a content size, including text font size, of the altered content according to a viewer's distance, content color to match viewer's dress color, content waving to get attention, content still from waving, or different content, or any combination of these.

15. The method of claim 1 wherein the imaging device positioned in a separate location than the first display.

16. The method of claim 1 wherein the imaging device is housed in at least one of a mannequin, a merchandise, a holder, or a stand, separate from the display.

17. The method of claim 1 wherein the imaging device incorporates a motor to rotate the imaging device itself or to rotate a front mirror to increase its field of view.

18. The method of claim 1 wherein multiple display units and imaging units are linked together, such that when a subject moves from a display unit A's coverage to a display unit B's coverage, a subject's eye is tracked such that display unit B will display content that related to what was displayed in unit A when the subject's gaze was detected in unit A.

19. The method of claim 1 wherein for each instance content is displayed on the first display, captured images associated with the content on the first display are analyzed to determine an interest level, where lower interest content will be replaced with content similar to high interest content either in a single display or using multiple display units.

20. The method of claim 1 wherein the image analysis comprises detecting a gaze blinking which is used to determine if a real human.
